(19) United States
(12) Patent Application Publication
(10) Pub. No.: US 2012/0053746 A1
(43) Pub. Date: Mar. 1, 2012

(54) SMART ENERGY DEVICE REPORTING "OPT-OUT" AUTONOMOUSLY DEPENDING ON USER SETTINGS

(75) Inventors: Jeff Donald Drake, Louisville, KY (US); Timothy D. Worthington, Crestwood, KY (US); Joseph M. Brian, Louisville, KY (US)

(73) Assignee: General Electric Company

(21) Appl. No.: 12/983,686

(22) Filed: Jan. 3, 2011

(51) Int. Cl. G06F 1/26

(52) U.S. Cl. 700/295; 700/286

(57) ABSTRACT

The present disclosure relates to a home energy management system for receiving data indicative of a current demand state of an associated utility supplying energy and transmitting data in response. The energy management system comprising at least one home energy consuming system and a controller being configured and arranged to communicate with the at least one home energy consuming system, the controller is capable of automatically responding to the demand signal adopting an opt-in or an opt-out status for the home energy consuming system in compliance or in noncompliance with the demand signal. The controller includes an interface allowing optional programming by an associated user to automatically provide an opt-out response wherein the demand for limiting energy consumption is not recognized.

### BACKGROUND

The following disclosure relates to energy management, and more particularly to a premise energy management system for management of household appliances, as well as other energy consuming devices and systems generally found in the home. The disclosure finds particular application to changing existing appliances via add-on features or modules and incorporating an override capability in response to a demand signal sent by a utility company.

The increasing cost of fuel prices and high energy usage rates at certain parts of the day have prompted utilities to charge higher rates during periods of peak demand. If peak demand can be lowered, then a homeowner or consumer can achieve a potential cost savings and the peak load that the utility company has to accommodate is reduced. This phenomenon coupled with cost efficient communication technology has brought about attempts to mitigate energy usage and to lower energy costs.

More particularly, one proposed solution is to provide a system where a controller at a home switches the actual energy supply to the appliance or control unit “on” and “off” during periods of high energy demand. However, this solution provides no active control beyond merely turning the appliance or device on and off Other proposed solutions include different, more sophisticated methods to determine when variable electricity-pricing schemes go into effect. These methods typically use phone lines, schedules, and wireless signals sent by the electrical company to the controller at the home. One problem with this approach is that different electrical companies use different methods of communicating periods of high electrical demand to the homeowner and some electrical companies have rate schedules for different times of the day.

Still, other electrical companies are moving to an advanced metering infrastructure (AMI) system. This system has the capability to communicate with home energy consumption systems such as appliances, HVAC, lighting systems, etc. in a home or office building. Known systems do not communicate directly with the appliance but instead use a variety of communications methods, systems, and protocols to communicate with a controller at the home. Further, a modular and standard method has not been created for communication devices to interface and communicate operational modes to the main controller of the appliance or system.

Additionally, home energy management (HEM) systems are being used to reduce energy consumption in homes and buildings. This development has prompted some electrical companies to implement or plan on implementing a system to communicate a demand signal to a home energy management system, and more particularly to a home energy consuming system, to activate a change in operation of the appliance or system that limits energy consumption being consumed by the system or appliance. This demand signal and resultant operational change in the appliance or system would certainly reduce the amount of energy consumption. However, if the operational change is automatically instituted in response to the demand signal, homeowners are prevented from having the option to control certain home energy consumption systems in a manner that is tailored to the specific energy usage needs of the individual consumer. Therefore, there is a need to provide an individual the option to automatically opt in or opt out of demand response events, e.g., peak pricing periods, when an associated utility sends a demand signal to a home energy management system that otherwise alters use or operation of an appliance or device within the home.

### SUMMARY

The present disclosure relates to a home energy management system for receiving data indicative of a current demand state of an associated utility supplying energy. The energy management system comprising at least one home energy consuming system and a controller being configured and arranged to communicate with the at least one home energy consuming system, the controller is capable of automatically responding to the demand signal by adopting an opt-in or an opt-out status whereby the home energy consuming system operates in compliance or in noncompliance with the demand signal.

Home energy consuming systems may include any combination of energy consuming appliances such as HVAC units, light fixtures, appliances such as refrigerators, washing machines, dishwashers, ovens, and other energy consuming devices located within a home. The energy consuming system may also include an individual appliance or device, or a group of appliances or devices.

The utility communicates a demand supply signal to the home and the home energy management system can be configured to limit energy consumption being consumed in the home. The controller may also include an interface allowing optional programming by an associated user to override the demand signal and thereby automatically provide an opt-out response wherein the demand for limiting energy consumption is not recognized.

The controller may include a memory that stores data relating to at least one of maximum or minimum price of electricity, price delta of electricity, maximum or minimum duration of a peak demand event, level of importance of peak demand event, maximum or minimum cooling or heating offset, maximum or minimum cooling or heating set point, maximum or minimum load adjustment percentage, and maximum or minimum load duty cycle percentage.

In one embodiment, a method is provided for automatically managing energy provided by a utility to a home environment that has an energy consuming system, device or appliance operatively associated with an energy management system that includes a controller and a user interface. The method includes receiving a demand signal from the utility and the energy management system automatically adopting an opt-in or an opt-out status in response to the demand signal whereby the home energy consuming system operates in compliance or in non-compliance with the demand signal.

An advantage of the present disclosure is a system that gives a user the ability to set up the appliances or devices to respond automatically to a demand signal provided by a utility or a third party company.

Another advantage of the present disclosure relates to a system that gives the user the ability to set up their home to react to energy events (e.g., peak pricing periods) from utilities or third parties automatically in whatever preference the homeowner chooses.

A further advantage of the present disclosure is associated with the ability of a user to update settings on individual devices or use a home energy management system to update settings that will automatically opt-in or opt-out of demand response events depending on the settings the user inputs.

Still other benefits and advantages will become apparent upon reading and understanding the following detailed description.

### BRIEF DESCRIPTION OF THE DRAWINGS

FIG. 1 is schematic representation of a home energy management system.

FIG. 2 is schematic representation of a method for automatically managing energy provided by a utility.

### DETAILED DESCRIPTION OF THE PREFERRED EMBODIMENTS

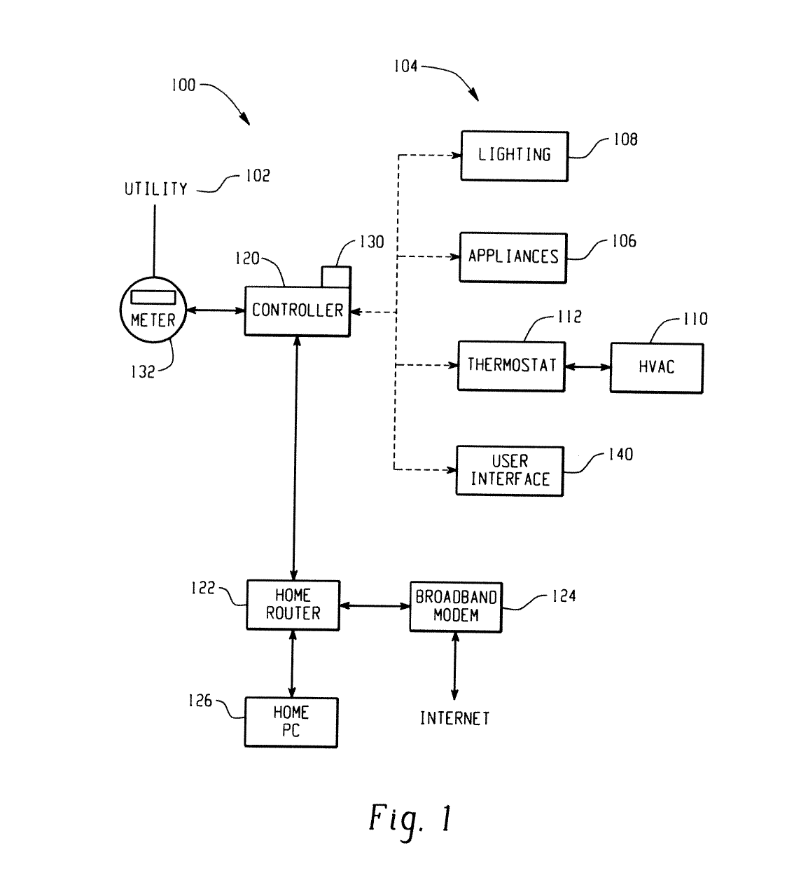

In accordance with the present disclosure, a system 100 shown in FIG. 1 handles energy management between an associated utility 102 or other third party and a plurality of energy consuming appliances, devices, or systems 104. In one embodiment, an advanced system 100 is provided to handle energy management between the utility 102 and appliances 106 or other devices such as a lighting system 108 or HVAC system 110 (and associated thermostat 112) that consume energy and are typically located within a home. Appliances 106 may include refrigerators, freezers, ovens, televisions, water heaters, computers, fans, dishwashers, washing machines, dryers or similar devices that consume energy in a home, one skilled in the art recognizing that this list is exemplary only and not intended to be a complete listing.

The system 100 preferably includes a controller 120 and a communication network represented by lines in and out of the controller that allow the controller to communicate with one or more of the appliances 106, the lighting system 108, HVAC 110, and/or with a home router 122 that communicates with the internet, for example through a modem 124 or with the home computer 126. The controller 120 preferably includes or communicates with a local storage or memory unit 130 configured to store data relating to set points, operating instructions or algorithms, historical operating information, etc. relating to the various energy consuming devices 104, and likewise to operate in association with a utility 102 (gas, electric, water, etc.) through meter 132 or through a wired or wireless device (not shown) that communicates with the communication network of the system. For example, this wired/wireless device acts as a go-between from the meter 132 to the energy consuming devices 104. The device may include two radios, a first radio on the input side that binds to the meter and transmits and receives information therebetween. A second radio is on the output side and this radio binds to demand supply modules for each appliance and again sends/receives information between the two.

The home energy management system receives data indicative of a current demand state of an associated utility or third party supplying energy and may transmit data in response. The controller 130 may communicate with each individual energy consuming device within the system and, additionally, the controller communicates with an associated utility. The controller handles energy management between the utility and home appliances, lighting, thermostat/HVAC, etc. with user choices incorporated in the decision making process, for example, though the use interface 140. The controller 120 may include notification of an energy saving mode based on a demand limit read from one or more of the utility meter, utility, third party or user. An energy savings mode of an appliance can thereby be controlled or regulated based on a priority level (e.g., low, medium, high or critical). The controller 120 will access the memory 130 stored instructions, set points, etc. relative to the energy consuming devices. Likewise, consideration to use energy from local storage and use of a local generator to offset a peak demand limit can be incorporated into the energy management considerations, or provide the ability to override a mode of energy savings through the controller or at the appliance, lighting, or thermostat/HVAC.

More particularly, the controller 120 interfaces between the utility 102 and the energy consuming systems 104 and transmits and receives data and signals therebetween. The communication of information in this manner comprises the backbone of smart grid technology whereby proper management of this information is employed to reduce energy usage rates, including communicating a peak demand, a demand priority rank of the appliances, what action (if any) that an energy consuming device should pursue, or whether a homeowner has programmed the controller to ignore the peak demand signal and opt out of potential energy and price savings operation of the energy consuming system.

The data and signals that are communicated between the utility and the controller comprise a broad range of information that may be categorized to reduce energy consumed by the energy consuming systems. This data or information may include a data spectrum of at least one category such as a price of the utility (electricity, gas, water, etc.), the change in price of the utility or a price delta, a duration of a peak demand or usage event, a level of importance of a peak demand event, a cooling or heating offset value, a cooling or heating set point, a load adjustment percentage and a duty cycle percentage. This information related to these categories can optionally be stored or saved in the memory 130 operatively accessed by the controller 120 and toggled or modified by the user through the user interface 140.

The utility 102 or other third party that provides energy may attempt to communicate a demand signal to the home energy management system to limit energy consumption being consumed by the home energy consuming system. The demand signal or event may comprise a function based on the peak demand period or the demand priority rank of appliances. A peak demand period, for example, can be based on the overall energy consumption of all homes and all energy consuming systems within a smart grid network of homes that are supplied energy by the utility. The peak demand period may also be based on the overall energy consumption of energy consuming systems of an individual homeowner depending on how the homeowner programs the controller to operate various energy consuming devices.

In one embodiment, the controller 120 is provided as a communicating intermediary between the utility 102 and the energy consuming systems 104. Each appliance 106 may have a communication interface that links itself to the controller. This interface can be power-line carrier (PLC), wireless, and/or wired. The controller 120 may be provided directly on the device within the energy consuming system, may be a module that is remote from the device, or can be a wireless device such as a personal computer or even a cell phone.

The module may be in the form of a special custom configured computer with an integrated and/or associated display. The module may communicate with devices in the home and store data generated by each device in a memory. The module may also comprise a plurality of software functions and other algorithms to enable the tracking and storing of device usage along with optionally providing energy reduction commands. The module may be integrated in a unitary housing, or if the display is not in the same housing, the display and computer are otherwise connected or associated when made operational and synchronized or tuned to work as a single unit.

The module may also be remote and provided in the form of a software program accessed by a router/gateway device in a home that collects information from devices and sends the data to a server. The server receives data and may provide control commands to the energy consuming devices. The module may be a custom configured internet-based program accessible by a computer and an integrated or otherwise connected/associated display designed as a single unit or may be implemented as a home computer such as a laptop or a desktop. This embodiment allows operating software to connect to the interne and manage the home energy management system through a remote server, for example.

The controller 120 may also include a user interface 140 that has an adaptable user input means and display for a user to provide command inputs and receive output signals at one or more device within the system. The user input means may comprise a series of buttons, knobs, switches, keypads or touch screens for a user to input data, signals or commands to the controller. The user may selectively utilize the interface and enter data into the controller memory or module memory 130.

The controller interface 140 allows the user to optionally program the home energy management system to automatically provide an opt-out course of action in response to the demand signal for limiting energy consumption. This opt-out response may automatically notify the utility that the demand signal is not recognized, although the system could also operate without specifically notifying the utility. This opt out function allows the home energy management system to automatically override the demand signal communicated by the utility and continue operating the energy consuming system or device in compliance or non-compliance with the demand signal.

This opt out feature gives the homeowner the ability to set up the appliances or devices to respond automatically to a demand signal provided by a utility or a third party company. The user/homeowner may have the ability to set up the energy consuming systems to react to energy events from utilities or third parties repeatedly and routinely in substantially whatever preference they choose.

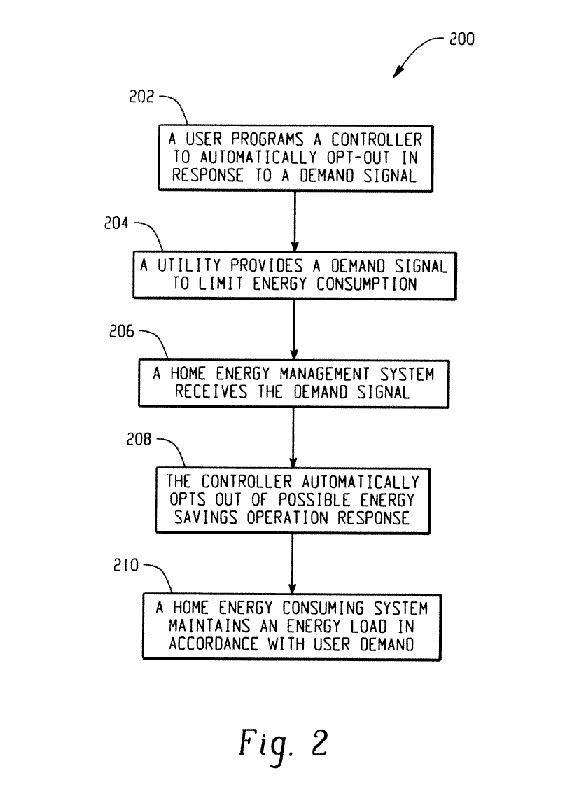

FIG. 2 schematically represents in a representative flow chart one preferred embodiment of the present disclosure. A method 200 for automatically managing energy provided by a utility to a home environment has at least one home energy consuming system operatively associated with an energy management system that includes a controller and a user interface. A user programs the controller to automatically opt-out of energy savings operation of an energy consuming device 202 e.g., does not increase the set point temperature of the central air conditioner in response to low, medium, or high demand response signals but will increase the set point temperature if a critical demand response signal is received. Thus the consumer programs the controller to act in this manner through the user interface and this set of instructions is saved in memory in order to automatically opt out of changing the set point temperature in low medium, and high demand response signals. If the utility send a demand signal 204 and the controller receives the demand signal 206 at one of these three levels to limit energy consumption, then the controller automatically opts-out 208 via the energy management system in response to the demand signal and the home energy consuming system maintains an energy load in accordance with user demand 210. On the other hand, if a critical signal is received, then the controller automatically opts in and changes the set point temperature. Thus, the home energy consuming system operates in compliance or in non-compliance with the demand signal based on the input from the homeowner stored in memory.

A homeowner/user would update settings through the user interface provided on a home computer, or the actual energy consuming device, and update the settings that are preferred to use for automatic opt-in or opt-out of events sent from the associated utility or third party energy provider. For example, the user can pre-program fields to set thresholds or values for autonomous “opt-out” such as: maximum or minimum price of electricity, a price delta/change of electricity, a maximum or minimum duration of the peak demand period, a maximum or minimum level of importance or criticality of the peak demand event, a maximum or minimum cooling or heating offset, a maximum or minimum cooling or heating set point, a maximum or minimum load adjustment percentage or energy reduction percentage, or a maximum or minimum load duty cycle percentage. Once these values, fields, or settings are established by the user, then the automatic opt-out or opt-in response would follow directly from the settings. The incoming signal is received and compared with the settings a user has established (depending on the data in the signal). If the data in the signal is within or outside the bounds of the user settings, then the opt-in or opt-out response respectively automatically follows.

More specific to the above example, in a thermostat, a user may set an opt-out value to trigger in response to any demand event sent with a set point change such as 70 degrees F. or above (for cooling). Therefore, any demand event or signal received from the associated utility that indicates a change of the thermostat to 70 degrees F. or above when operating in the cooling mode, the controller at the thermostat will automatically opt-out of the event and leave the settings as originally set by the user. This opt-out value could also be used for the set point offset field, load percentage field, criticality field, and so on. These fields are all related to a smart energy profile but similar fields could be used for any energy management system or protocol. The same could occur for individual appliances, i.e. percentage load field, criticality level, duty cycle, etc. The reverse could also be used to set an automatic opt-in of events for any of the fields listed herein.

When a demand signal or an event is sent from the associated utility or third party energy provider, the homeowner/user has previously decided whether to opt-in or opt-out of the events. This system and method gives the user the ability to set up the devices to respond automatically to the user's preferred liking.

The disclosure has been described with reference to the preferred embodiments. Obviously, modifications and alterations will occur to others upon reading and understanding the preceding detailed description. It is intended that the disclosure be construed as including all such modifications and alterations.

1. An energy management system receiving data indicative of a current demand state of an associated utility supplying energy, and transmitting data in response, the system comprising:
at least one home energy consuming system; and
a controller being configured and arranged to communicate with the at least one home energy consuming system, the controller capable of automatically responding to the demand signal adopting an opt-in or an opt-out status for the home energy consuming system in compliance or in noncompliance with the demand signal.

2. An energy management system of claim 1 wherein the controller further includes a module in communication with the at least one home energy consuming system.

3. An energy management system of claim 2 wherein the module includes a user interface.

4. An energy management system of claim 2 wherein the module is remote from the at least one home energy consuming system.

5. An energy management system of claim 1 wherein the controller wirelessly communicates with at least one of the at least one home energy consuming systems.

6. An energy management system of claim 1 wherein a plurality of signals may be communicated, the signals comprise at least one of a peak demand limit and a demand priority rank of associate appliances within a home energy consuming system.

7. An energy management system of claim 1 wherein the utility communicates a demand signal to the home energy management system to limit energy consumption being consumed by the home energy consuming system.

8. (canceled)

9. An energy management system of claim 1 wherein the controller includes a memory that stores data relating to at least one of maximum or minimum price of electricity, price delta of electricity, maximum or minimum duration of a peak demand event, level of importance of peak demand event, maximum or minimum cooling or heating offset, maximum or minimum cooling or heating set point, maximum or minimum load adjustment percentage, and maximum or minimum load duty cycle percentage.

10. (canceled)

11. A method for automatically managing energy provided by a utility to a home environment that has at least one home energy consuming system operatively associated with an energy management system that includes a controller and a user interface, and a plurality of energy consuming devices, the method comprising:
receiving a demand signal from the utility; and
the energy management system automatically adopting an opt-in or an opt-out status in response to the demand signal whereby the home energy consuming system operates in compliance or in non-compliance with the demand signal.

12. The method for automatically managing energy in accordance with claim 11 further comprising indicating the adopted opt-in or opt-out status to the utility via the energy Management system in response to the demand signal.

13. The method for automatically managing energy in accordance with claim 11 further comprising optionally programming the controller by an associated user to automatically respond to the demand signal with an opt-out status wherein the system operates in non-compliance with the demand signal.

14. The method for automatically managing energy in accordance with claim 11 further comprising optionally programming the controller by an associated user to automatically respond to the demand signal with an opt-out status selectively for one or more of the energy consuming devices.

15. The method for automatically managing energy in accordance with claim 14 further comprising storing data in a memory individually for one or more of the energy consuming devices relating to at least one of a maximum or minimum price of electricity, a price delta of electricity, a maximum or minimum duration of a peak demand event, a level of importance of peak demand event, a maximum or minimum cooling or heating offset, a maximum or minimum cooling or heating set point, a maximum or minimum load adjustment percentage and a maximum or minimum load duty cycle percentage.

16. The method for automatically managing energy in accordance with claim 15 further comprising allowing an associated user to selectively enter data individually for one or more of the energy consuming devices into the controller memory via the user interface.

17. The method for automatically managing energy in accordance with claim 11 wherein the controller module is remote.

18. The method for automatically managing energy in accordance with claim 11 further comprising wirelessly communicating between the utility and the energy management system.

19. The method for automatically managing energy in accordance with claim 11 further comprising transmitting and receiving at least one of a plurality of signals and commands to associated appliances within the energy management system.

20. The method for automatically managing energy in accordance with claim 19 wherein the plurality of signals comprise at least one of a peak demand and a priority rank of associate appliances within the energy management system.

21. The method for automatically managing energy in accordance With claim 11 further comprising maintaining an energy load provided by the utility in accordance with the status provided by the energy management system.

22. The method for automatically managing energy in accordance with claim 11 further comprising storing data in a memory relating to at least one of a maximum or minimum price of electricity, a price delta of electricity, a maximum or minimum duration of a peak demand event, a level of importance of peak demand event, a maximum or minimum cooling or heating offset, a maximum or minimum cooling or heating set point, a maximum or minimum load adjustment percentage and a maximum or minimum load duty cycle percentage.

23. (canceled)
